(19) United States
(12) Patent Application Publication
(10) Pub. No.: US 2013/0129338 A1
(43) Pub. Date: May 23, 2013

(54) Protective Lens Cover

(71) Applicant: Michael Dowell, Lexington, KY (US)

(72) Inventor: Michael Dowell, Lexington, KY (US)

(21) Appl. No.: 13/651,511

(22) Filed: Oct. 15, 2012

Related U.S. Application Data
(63) Continuation-in-part of application No. 12/849,968, filed on Aug. 4, 2010, now Pat. No. 8,292,523.

(51) Int. Cl. G03B 11/04; G02B 27/00

(52) U.S. Cl. CPC G03B 11/041; G02B 27/0006
USPC 396/448; 359/511

(57) ABSTRACT

A padded protective frusto-conical shaped cup covering sized to slip over a camera lens is disclosed. The covering is designed to fit on either the front portion of the lens or the rear lens mount. The protective covering has beveled side walls which allow it to fit easily on a variety of different lenses. The protective covering is made from two separate layers of material, an outer cup made from a firm yet flexible material, and the inner liner made from a soft pliable material. In one embodiment the outer cup includes a circumferential retaining ring on the inside of the cup to help secure the cup onto a lens. The soft inner liner allows the covering to easily adhere to the camera lens, and also provides impact protection. The outer cup provides additional impact protection. The outer cup also includes a domed top portion which provides a crumple zone or impact bumper. In one embodiment the outer cup has an opening in the domed top, and in one embodiment thereof there is a clear optical grade lens or filer lens inserted or incorporated into the opening, which allows the camera user to take a photograph without removing the protective lens.

### CROSS REFERENCE TO RELATED APPLICATIONS

This application is a continuation in part of U.S application Ser. No. 12/849,968, filed on Aug. 4, 2010, and incorporated herein by reference.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to a padded protective covering for protecting both the front lens and rear mount portions of a camera lens, or other optical lensed devices.

2. Description of the Related Art

Camera lenses are both fragile and expensive. Professional photographers often have many lenses, and these lenses can represent a significant investment. A camera lens is constructed of a series of lens elements, although a filter usually consists of a single lens. The primary component is a tube, that is referred to as a lens barrel, which internally contains optical components including glass or crystal optic lenses, mirrors or reflector plates and often have other mechanical focusing components. The optical lenses within the barrel provide a variety of optical properties that allow photographers to take a variety of different photographs. Camera lenses and their components are well known in the art. The specific components of camera lenses, except for the external structure as it relates to the present invention, form no part of this invention. The term camera lens as used herein means the entire component of the barrel with interior optical lenses and focus components.

At one end of the barrel there is a mount for attaching the camera lens to the camera, and at the other end, referred to as the front end, there is an optical lens. The optical lens itself is generally made of a glass or crystal compound. In some cases there are lenses made of clear optical grade plastics such as Lucite, but because of the optical properties required for photography, the vast majority of lenses are made from glass or crystal. Some camera lenses are convex and are often referred to as fish eye lenses, due to their shape. All of these lens components are breakable and can be chipped or nicked if hit with something hard, granular or sharp. The barrel is typically made of light steel, alloy, aluminum, or plastic, which is brittle and relatively easily damaged or cracked, and is typically relatively thin and can be easily dented. The mount is typically made of thin metal or plastic and retained on the camera lens by a series of small tabs that fit into corresponding recesses in the lens mounting plate on the front of the camera. The mount is fragile and can be easily damaged.

Many camera lenses have a threaded filter ring at the end, which allows the addition of a filter optical lens that can provide some photographic enhancement features. Such filter lenses are well known in the art. The filter ring is on the inside circumference of the front of the barrel, so the lens filter mounts inside at the end of the barrel. This filter lens can provide some very minimal protection of the optical lens at the end of the camera lens, it is primarily designed for optical enhancement but because it is also glass or thin optical grade plastic it can easily be broken.

Many of the components of the camera lenses are fragile and easily damaged. As mentioned, lens barrels are typically made of aluminum or plastic, which can be somewhat brittle and can be easily dented, cracked or damaged. Inside large camera lenses, such as telephoto lenses, there are numerous smaller optical lenses and mirrors to achieve various optical and focal properties. The components are typically made of plastic, glass, or crystal and are quite fragile, and can be easily damaged. There is a need, therefore, for ways to protect the camera lens, the glass optical lenses and the mounting components at the end of the camera lens.

Many photographers use their cameras and lenses in a wide variety of locations. Many sports, wild life, journalists and correspondents use their equipment out of doors and often in very rugged terrain. In many situations the photographer carries the equipment through a wide variety of terrain. Most photographers have a variety of carrying cases for their equipment, and generally these cases are well padded. These cases are strictly for transport therefor, in many situations the photographer will have equipment out and ready to use. Often the photographer will have at least one camera slung over his or her neck, ready to be used, and will also often have one or more replacement lens slung over the neck or shoulder. Because of the cost of these camera lenses there is a need for a reliable method of protection.

The most common form of protection for the camera lens is the standard lens cap, which is a hard plastic covering that snaps into the filter ring at the end of the camera lens. An example of this type of cap can be seen in U.S. Pat. No. 4,600,278, to Saito. This provides a minimal degree of protection to the glass optical lens at the end of the camera lens, but does not protect the lens barrel and internal components from impact damage. This type of plastic lens cap also cannot protect the optics of a lens from an unusually hard impact. These lens caps only fit a single sized diameter lens, and are often somewhat difficult to keep in place. Lens caps are primarily designed to prevent fingerprints and smudges off the outer lens element. There is a need, therefore, for a single lens covering that can fit multiple sized lenses, and can be easily place on, and removed from, the lens.

A second form of lens protection is a case or covering that covers the entire lens, and in some cases the camera body as well. An example is U.S. Pat. No. 4,549,589 to Nguyen. The '589 patent discloses a case that fits over the body of the camera and has an attachment lens tube case that fits over the lens or lenses, and can be attached to the camera body case. How ever in most cases this will not fit or protect larger telephoto or zoom lenses. This provides good protection, and is useful for transporting the camera and camera lens, but is not convenient or practical for protecting the camera lens while mounted on the camera body, and does not allow for easy installation or removal. There is a need, therefore, for a lens covering that provides good protection and is easily installed and removed from a lens.

A third form of camera lens protector is the “hood” which is actually a tube or cone that is mounted to the end of the camera lens. They are primarily made of plastic and in some cases metal or carbon fiber on larger lenses, while other third party “hoods” can be made of soft material. Fish eye lenses as referred to earlier will often have a built in “hood” these lenses are even more prone to collateral damage due to the fact that the hood is part of the pre mentioned barrel and is always exposed and protruding. An example is U.S. Pat. No. 7,682,091 to Zeck. The tube extends from the end of the camera lens and so provides some protection for the glass optical lens at the front end. But it provides no impact resistance for the lens or barrel. Additionally this type of attachment makes the camera lens long and much more likely to impact hard surfaces during transportation. Lens hoods are additionally designed to fit only a single sized lens. Lens “hoods” are primarily designed to aid in optical performance with the purpose of shading the end element from direct light which causes what is commonly known in the art as flaring and or ghosting, lens hoods are not designed or intended for reliable protection.

A final example of prior art lens covers is the “Soft Lens Cover” disclosed in U.S. patent application Ser. No. 12/221,277 to Elowitz, filed Aug. 1, 2008, published as US 2010/0027120, and now abandoned. This application discloses a soft, thin covering made of open cell neoprene or other thin textile material, that stretches over the end portion of the lens or lens “hood”. In one variation the soft lens cover can contain a hard plastic disc insert that is intended to provide protection for the camera lens. This application is drawn to a single layer of very thin material that can be stretched over the end of the camera lens, and which will provide only a bare minimum of protection for the camera lens. This device is designed only for the front end of the camera lens and is not suitable for protection of the lens mount. Additionally, the plastic insert creates a hard surface directly against the end of the camera lens, which means that the force of an impact will be transferred directly to the camera lens. In many cases an impact, such as a blunt force or dropping the camera and lens can breach the light weight foam material and fracture the hard plastic disc therefore scratching the exposed outer element of the lens thus offering no protection and extending collateral damage. There is a need, therefore, for a means for protecting all components of expensive camera lenses, and a covering that can fit and be easily place onto similarly sized camera lenses.

Larger high end telephoto and zoom lenses have very little if any protection devices available. The manufacturer will sometimes include, or sell separately, a canvas cap, which is designed to keep dust, fingerprints and smudges off the outer lens element. However the canvas cap is not intended or designed as impact or damage protection. There is certainly a need, therefore, for a means for protecting all lenses ranging from amateur to professional camera lenses, and a covering that can fit and be easily placed onto relatively sized camera lenses.

### SUMMARY OF THE INVENTION

The invention provides a protective lens cover or guard made of a resilient exterior shell cast out of Santoprene or other nitrile rubber based material. The interior insert liner is made of Neoprene or foam based material that has Jersey or soft cloth adhered to it on the contact surface. The Neoprene liner is bonded to the interior of the Santoprene shell with a pliable non-hardening adhesive to prevent slippage and separation of the two components. The Jersey lining prevents the invention from scratching or bonding to the barrel of the lens. The invention is sized to fit easily and securely over the end of a camera lens. Because of the configuration of the lens cover it can be used to cover and protect both the front end of the camera lens, and the rear mount end of the camera lens. The beveled walls of the lens cover allows the lens cover to easily slip on while avoiding compression build up when placing it on a lens and easily slide off of a lens due to the beveled walls that avoid creating a suction. This same beveled wall configuration also allows the lens cover to fit wide variety of lenses that are similar, though not identical, in size.

The lens cover is made of three layers of protective material. The outer layer, referred to herein as the protective outer cup, is made of a firm yet flexible material such as Santoprene™ vinyl, (Santoprene is a trademark of the ExxonMobile Corporation for their proprietary line of thermoplastic vulcanizate (TPV)), vinyl or nitrile based compound. The second inner layer, referred herein as the padded inner liner, is made of a softer material such as neoprene, or other similar soft and spongy / foam materials that have good compression and decompression properties. The third interior layer is made of Jersey or other suitable soft cloth material designed to protect the finish of the lens barrel and lens element while preventing scratching of the lens barrel and exposed element while applying or removing the lens cover. The lens cover also has a tether made of nylon or other textile strap or cord variant that is affixed to the lens cover and is of varying length. The tether is used to secure the lens cover to various locations on the lens or camera to prevent the lens cover from becoming dislodged or misplaced. The lens cover is in the shape of a beveled cylindrical cup having a raised domed end. The bevel of the lens cover walls allows the cover to fit easily onto either the lens end or the mount end of the camera lens and disperses compression and vacuum encountered during applying and removing the lens cover. The soft inner liner allows the cover to fit snuggly and securely without potentially damaging the delicate components of the camera lens or the finish of the lens barrel. The combination of the soft inner liner and the protective outer cup provides excellent dispersion and shock absorption protection should the end of the camera lens impact something hard or is dropped on the lens. Additionally, in the event of sudden or high impact the domed end of the lens cover reacts like an airbag creating an enclosed, compressed air buildup while providing additional room or give in the event of impact at the front end of the lens. This feature also provides additional shock absorption and protection to the rest of the camera lens and body. The domed portion of the lens cover also provides extended protection to lenses that have a convex or fish eye lens element.

In one variation of the lens cover there is circular opening in the domed top of the lens cover. This circular opening allows a photographer to use the lens cover to protect the lens, but also allows the photographer the ability to take a picture with the lens cover in place on the lens. In another variation the central opening is threaded to allow lens filters to be added.

Another feature of the lens cover is a raised retainer ring that is cast into the interior wall at the base of the Santoprene outer shell. The purpose of this retainer ring is to provide additional gripping power to the lens cover. The built in retainer ring accomplishes this by sliding over the extended smaller circular portion found at the element end of most lenses or by gripping the filter itself when an enhancement filter is mounted to a lens.

### BRIEF DESCRIPTION OF THE DRAWINGS

FIG. 1 is an exploded perspective view showing the main components of the invention.

FIG. 2 is an exploded perspective view showing the underside of the components of the invention.

FIG. 3 is an exploded perspective view of the components of the inventions showing an alternate attachment point for the tether.

FIG. 4 is an exploded cross sectional of the invention showing the protective cup and the components of the inner liner.

FIG. 5 is a cross sectional view of the invention showing the inner liner in place within the protective cup.

FIG. 6 s an exploded cross sectional of the second embodiment of the invention with the retainer ring, and showing the protective cup and the components of the inner liner.

FIG. 7 is a cross sectional view of second embodiment of the invention showing the inner liner in place within the protective cup.

FIG. 8 is a perspective view of the protective cover attached to a camera by the tether.

FIG. 9 is a side view of the second embodiment of the invention, with the retainer ring, in position to be place on a camera lens.

FIG. 10a is a partial cut away of the protective cover in position to be place on a camera lens, and FIG. 10b is the same protective cover on the camera lens.

FIG. 11a is a partial cut away of the protective cover in position to be place on a camera lens, and FIG. 11b is the same protective cover on the camera lens, where the lens of FIG. 11 is slightly larger than the lens of FIG. 10.

FIG. 12a is an exploded view of two protective covers in position to be place on the mount end and the front end of a lens, FIG. 12b shows one of the protective covers on the front end of the lens, and FIG. 12c shows both protective covers on both ends of the lens.

FIG. 13a is a side view of a protective cover with a loop at the end of the tether, and FIG. 13b is a side view of the protective cover on a lens with the tether secured on the other end of the lens.

FIG. 14 is an exploded view of an alternate embodiment of the invention with an opening in the domed top.

FIG. 15 is an exploded view of an alternate embodiment of the invention with a lens to be incorporated into the opening in the domed top.

FIG. 16 is a cross section side view showing the lens in position in the opening in the domed top.

FIG. 17 is a cross section side view of a second version of the alternate embodiment having a retaining lip in place within the opening to hold the lens.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

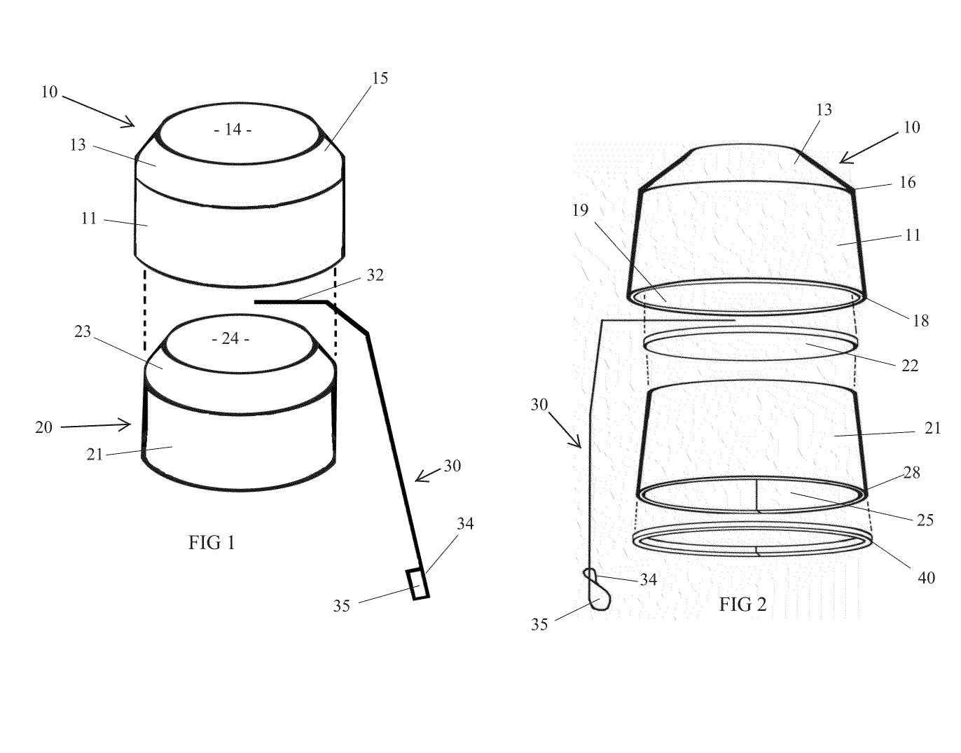

An overview of the main components of the invention is shown in FIG. 1. The lens cover 60 consists of a protective outer cup 10, a padded inner liner 20 placed inside, and a tether 30 that allows the lens cover 60 to be easily attached to a camera. The lens cover 60 is a frusto-conical cylinder created by a beveled side wall 11, with a raised domed top 15 attached at the top end. The inner liner 20 is in the same shaped as the outer cup 10 and is sized to fit within the outer cup 10. The frusto-conical shape allows the lens cover 60 to easily slip on and come off the lens, and also allows the lens cover 60 to fit lenses having differing diameters.

As seen in the exploded perspective views of FIGS. 2 & 3, and the cross section views of FIGS. 4 & 5, the protective outer cup 10 is a thin walled beveled cylindrical shaped cup, that is defined by a beveled cup wall 11 that attaches to the dome wall 13, which is then attached to the circular shaped cup top 14, to create the domed top 15. The outer cup 10 is generally made from a single piece of material and each component adjoins the other directly. The beveled cup wall 11 creates an opened end 19 with an opening circumference 18 at the bottom of the protective outer cup 10. There is a top circumference 16 at the top of the beveled cup wall 11 where it meets the domed top 15. Because of the frusto-conical geometry of the lens cover 60, the opening circumference 18 is slightly larger than the top circumference 16, which gives the cylindrical cup wall 11 the bevel. The dome wall 13 attaches directly to the top circumference 16 and the circular cup top 14 attaches directly to the dome wall 13 to create the domed top 15. The cup wall 11 is relatively thin, and there is an interior space 12 formed on the inside of the outer cup 10, with an inner surface 17 formed on the inside of the cup wall 11.

In the preferred embodiment the domed top 14 is a circular disc with a diameter of 2 to 2.25 inches. The cup wall 11 is 1.4 to 2.0 inches in height, and the domed wall 13 is 0.6 to 0.75 inches in height. The inside diameter of cup wall 11 at the top circumference 16 is 3.73 inches, and the opening circumference 18 is 3.94 inches. In other embodiments the lens cover 60 can be any size to fit corresponding lenses, so the diameters (and circumferences) of the components will vary as needed. Alternative sizes are set out below.

The outer cup 10 is made from a thin flexible yet firm material which can hold its shape and has impact resistance properties. In the preferred embodiment the outer cup 10 is made of a single piece of Santoprene rubber, which is injection molded into the appropriate beveled cylindrical cup shape. This type of material is flexible and slightly compressible, but has enough stiffness to hold its form. In the preferred embodiment all of the components of the protective outer cup 10 are molded in a single piece of material. In other embodiments can be made of any other suitable molded soft plastic or vinyl including soft PVC or ABS. It is also possible and within the conception of the invention to make the outer cup 10 from leather, since this is a common material for camera equipment covering. In the most preferred embodiment the outer cup 10 is made from 2 mm thick Santoprene rubber. The outer cup 10 can vary in thickness to produce appropriate strength and compression properties. The most common thickness for the wall 11 of the outer cup 10 will be between 1.5 mm to 6 mm thick, although for larger lens covers 60 it is possible for the wall 11 to be thicker.

Santoprene typically is black, but it is possible to include pigments and dyes in the molding material to produce a lens cover 60 in any color or shade. There are a number of camera and lens companies that produce their products in differing colors, and it is within the conception of the invention to produce the lens cover 60 in any of these colors. It is also possible to produce the lens cover 60 in any other color, and to allow patterns or other indicia or markings to be molded into the santoprene protective outer cup 10. The lens cover 60 could be produced in, for example, college or team colors, or camouflage, among others, or with team or company logos incorporated into the outer cup 10.

The protective inner liner 20 is sized and shaped to correspond to, and fit inside, the interior space 12 of the outer cup 10. The inner liner 20 is shown in FIG. 1 as a single component, but in the preferred embodiment, as shown in the exploded views of FIGS. 2 & 3, it is made of two separate pieces of soft spongy foam material: the liner wall 21 and the dome liner 22. The liner wall 21 is a frusto-conical tube sized and shaped to fit securely against the inner surface 17 of the outer cup 10. The dome liner 22 is flexible flat disc that is pressed up and into the inside of the domed top 15, and takes the shape of the inside of the domed top 15. This configuration allows the inner liner 20 to be simply and easily cut from sheets of neoprene or other soft material. The inner liner 20 is comprised of a beveled liner wall 21 which is defined by a liner top circumference 26 and a liner opening circumference 28, wherein the liner opening circumference 28 is slightly larger than the liner top circumference 26, which creates a beveled cylindrical shape to the inner liner 20. The inner liner 20 includes the dome liner 22, which creates a liner dome wall 23, and a liner top 24 when pressed into the domed top 15. When the inner liner 20 is in place inside the interior space 12 of the outer cup 10, the liner wall 21 fits snuggly against the inner surface of the cup wall 11, the liner dome wall 23 is snug against the dome wall 13, and the liner to 24 is pressed against the cup top 14 with no space between the inner liner 20 and the outer cup 10. In one embodiment the inner liner 20 is securely attached to the outer cup by conventional means, including gluing. It is also possible to mold the two components together. The inner liner 20 can be attached or adhered within the inner space 12 by any known conventional method. The liner wall 21 is made from a relatively thin piece of soft and pliable material. This creates a liner interior 25 space within the inner liner 20. In an alternate embodiment the inner liner 20 consists only of the beveled liner wall 21, leaving the interior of the domed top 15 without the padding of the inner liner 20.

In the preferred embodiment, the components of the inner liner 20 are made from Neoprene (polychloroprene), or other similarly soft but flexible and pliable material, including, but not limited to rubber, latex rubber, and other similar synthetic rubber polymer substitutes such as Nitrile (butadiene acrylonitrile), or Butadyl (carboxylated acrylonitrile butadiene rubber with polymer additives). In the preferred embodiment the inner liner 20 is made from 6 mm thick neoprene. It is possible for the material of the inner liner 20 to range in thickness from 1 mm to 12 mm thick, depending on the size of the outer cup 10. The softness of the material provides impact resistance and shock distribution. It also allows the inner liner 20 to move and form around the components of the camera lens 50 and is soft enough so that it does not harm the components of the camera lens 50.

In the preferred embodiment there is a thin layer of Jersey cloth adhered to the inside of the liner wall 21. This is accomplished by sewing the jersey material to the neoprene of the inner liner 20. This prevents the lens components, either the top of the lens or the lens mount as described below, from sticking to the inner liner 20. In some embodiments there is also a lycra or spandex strip 40 that covers the bottom edge of the inner line 20, to prevent damage to the inner liner 20. Neoprene, the material used for the inner line 20 in the preferred embodiment, is a soft spongy material that can be easily damaged. The lycra strip 40 covers the neoprene and protects it from damage. With the Jersey cloth adhered to the inside of the liner wall 21 and the lycra stip 40 attached to the bottom of the inner liner 21, and with the inner liner 21 attached in place against the inside wall 17 of the outer cup 10, there is no exposed neoprene material that could potentially be damaged. This improves the durability and useful life of the lens cover 60.

The lens cover 60 also includes a tether 30, as seen in FIGS. 2 & 3, which is used to attach the lens cover 60 to the camera. The tether 30 is a thin cloth strap used to attach the lens cover 60 to the camera or other attachment point. Such tethers are well known in the art. The tether 30 can be made of any suitable material, such as nylon or cotton, but can also be made of an elastic material. The tether 30 has a cover end 32, which is attached to the lens cover 60, and a camera end 34 which can be attached to the camera. In the preferred embodiment the cover end 32 is attached to the inner liner 20 between the inner liner 20 and the outer cap 10 by means of sewing or gluing. The camera end 34 will generally have a loop 35 which will allow easy attachment to an attachment point on the camera. In one configuration the loop 35 is folded in on itself to create a slip knot that can be easily tightened onto an attachment point. Such attachment points on cameras are well known in the art.

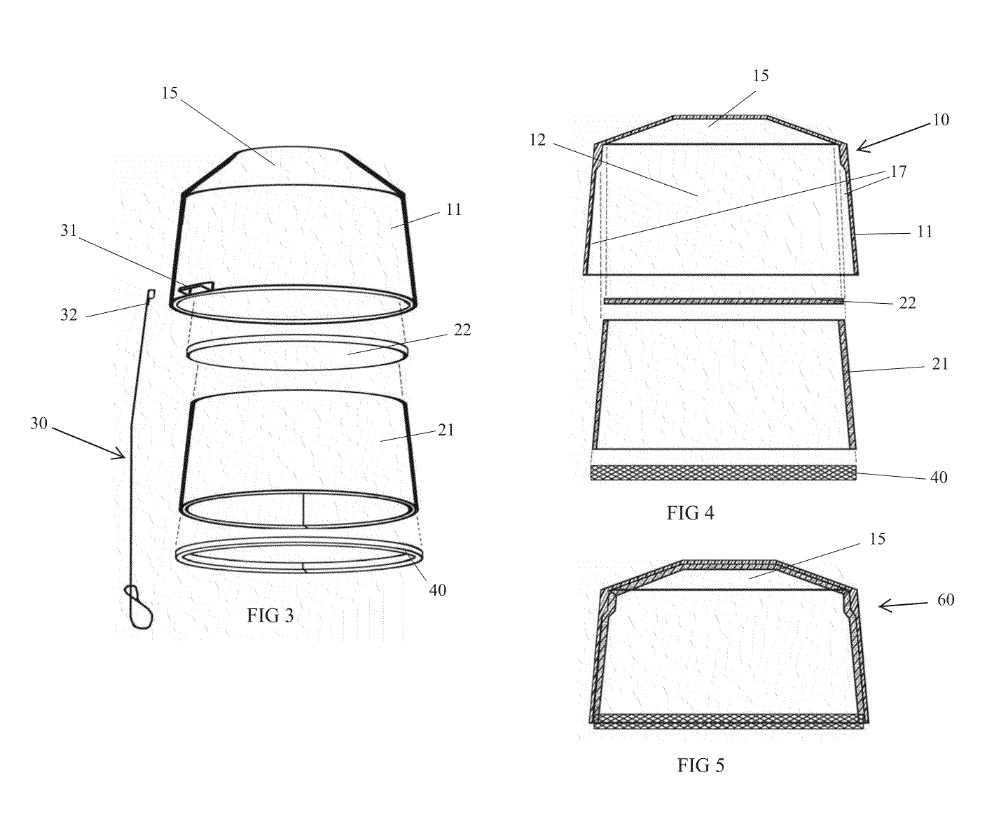

FIG. 3 is an alternate embodiment showing an alternate version of the tether attachment on the outer cup 10. This form of attachment is most commonly used in the larger variations of the lens cover 60. In this version there is a standard attachment clip slot 31 on the lower exterior of the outer cup 10, and the tether 30 can be attached by looping through the attachment slot 31. Clip slots 31 are standard size, which allows the lens cover 60 of this variation to be attached to straps having a standard size clip attachment.

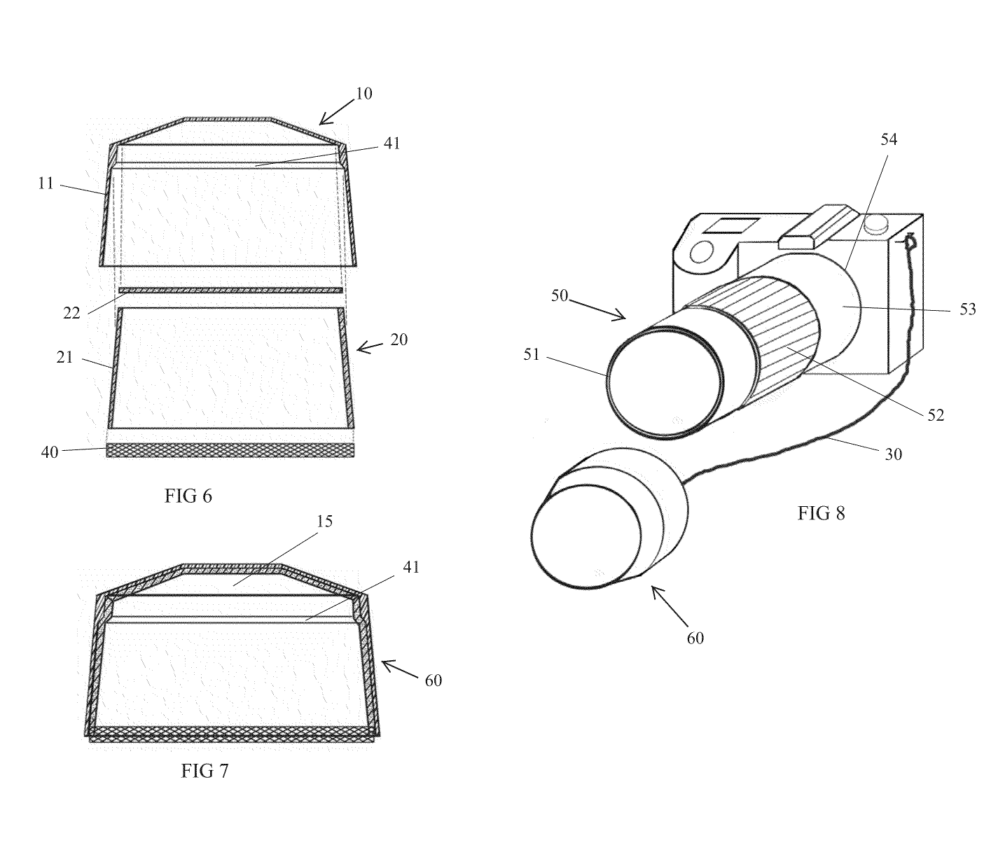

In a second embodiment of the lens cover 60, there is a retainer ring 41 located on the inside surface 17 of the beveled wall 11 of the outer cup, as seen in the cross section views of FIGS. 6, 7 & 9. As seen in FIG. 6, the retaining ring 41 is positioned approximately two thirds of the way up the inner surface 17 from the bottom opening 19. The retainer ring 41 runs circumferentially around the upper inside surface 17 of the beveled wall 11. It is made by molding the material thicker at that point. The standard thickness of the beveled wall 11 is 0.08″, and the retainer ring 41 is typically 0.015″, although the thickness can vary depending on the overall size of the lens cover 60. The purpose of this ring is to provide additional gripping power to the lens cover 60. The retainer ring 41 accomplishes this by sliding over the extended smaller circular portion found at the element end of most lenses 50 or by gripping the filter itself when an enhancement filter is mounted to a lens.

As can be seen in FIGS. 8 & 9, a typical camera lens 50 has a slightly tapered front end 51. This taper is created by the focus ring 52 being slightly larger in circumference than the lens barrel 53, and in some cases having a lens filter attached to the front end 51 which has a slightly smaller diameter than the front end 51. The beveled feature of the liner wall 21 and the cup wall 11 is designed to roughly correspond to the taper at the front end 51 of the camera lens 50. The mount end 54 of the camera lens 50 also has a slight taper due to the lens mount itself The liner interior 25 is sized to roughly correspond to the circumference of the lens barrel 53. The neoprene or other soft material of the inner liner 20 allows the lens cover 60 to fit over and snuggly attach to either the front end 51 or the mount end 54 of the camera lens 50, but have enough give so that it does not harm the delicate components of either end of the lens 50. The beveled feature of the lens cover 60, with the opening larger than the top inside circumference configures the lens cover 60 to be easily placed onto a lens 50, and allows the lens cover 60 to easily slip onto the lens 50, and slip into place securely on the lens 50.

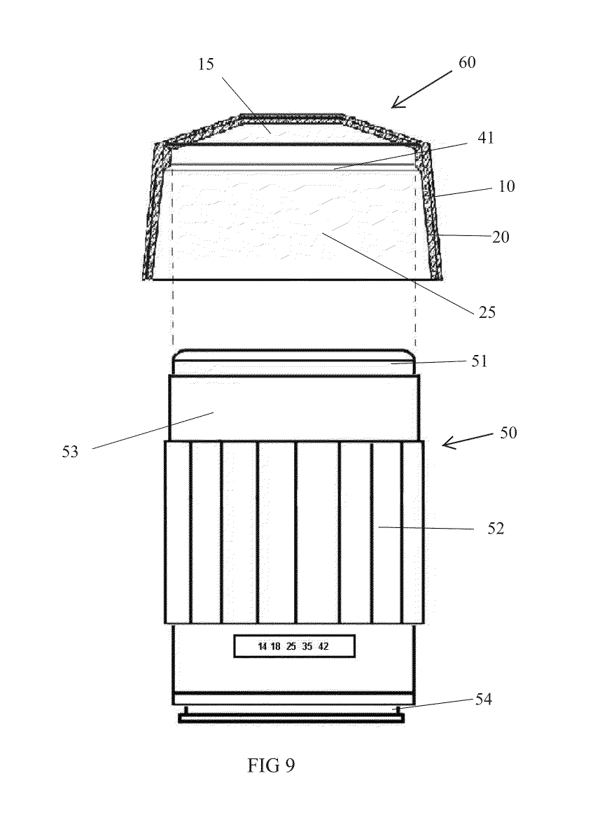

FIG. 9 shows the lens cover 60 with the retainer ring 41 in position to attach to the front end 51 of a lens 50. When the proper size lens cover 60 is selected for the specific diameter of the lens 50, the front end 51 of the lens 50 will be sized to fix snugly within the circumference of the retainer ring 41. This is shown by the dashed lines, which show the lens 50 fitting into the inside 25 of the inner liner 20, and the lens front end 51 fitting tightly within the retainer ring 41. In the embodiment with the retainer ring 41, and the properly sized lens 50 and lens cover 60, the components attach easily and securely. The bevel of the lens cover 60 still allows the lens cover 60 to be easily slide onto the end of the lens 50, and the domed to 15 provides a crumple zone and end bumper protection to the lens 50 and the camera, and described in detail below. Additionally, because of the design of the standard lens 50, the mount end 54 is typically the same diameter as the front end 51. Because of this, the lens cover 60 with the retainer ring 41, can also fit snuggly and securely on the mount end 54 of the lens 50.

The lens cover 60 is designed to provide good impact protection for the camera lens 50. This will also protect the camera itself because the camera lens 50 is attached to the camera by an inflexible camera mount. The lens cover 60 provides impact protection by two means. The first means is the soft material from which the lens cover 60 is constructed. Neoprene is a soft spongy material, which allows it to give when it comes into contact with components of the camera lens 50, thus allowing it to form around either the front end 51 or the mount end 54 of the camera lens 50. The neoprene also provides shock absorption and dispersion should the lens cover 60 come into contact with a hard material. In addition the outer cup 10 is made from a semi-soft material, such as Santoprene, which also has some give, and provides additional impact protection. Finally, when the lens cover 60 is in place on the camera lens 50 the domed top 15 extends slightly from the end of the camera lens 50, and creates an open air pocket between the end 51 of the camera lens 50 and the end of the lens cover 60. This provides a crumple zone, or room for movement should the extreme end of the lens cover 60 come into contact with a hard surface or material. The additional room provides additional shock absorption in the event that the domed cup top 14 bumps or hits something hard. The lens cover 60 also provides protection from the elements, such as sand, rain, saltwater or snow as well as many other contaminants or abrasives. When in position on the lens 50, the inner liner 20 provides a protective seal around the lens 50. This protective seal is not waterproof, but it is sufficiently tight to protect the lens 50 from rain or snow, or even from spills from drinks

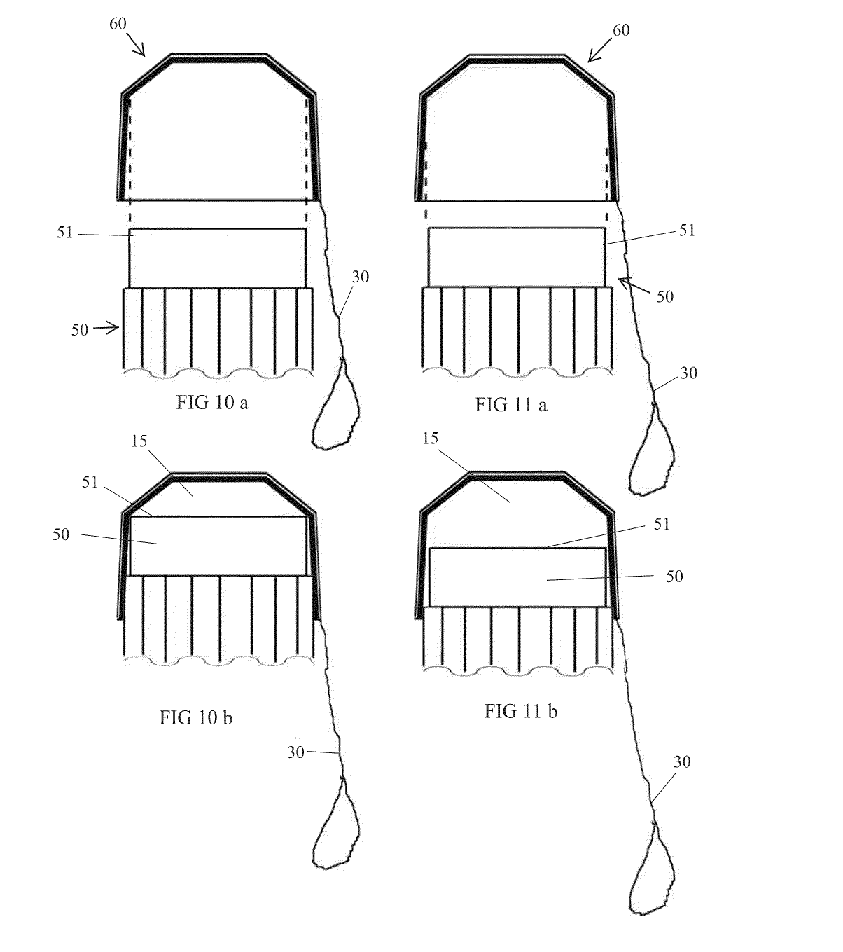

Camera lenses come in a wide variety of sizes, from short and squat close up lenses, to long telephoto lenses that at the extreme can be a couple of feet long. The lens cover 60 can be produced in a variety of sizes to fit on the end of any size camera lens. Most lenses have a fairly standard circumference, which are generally describe by the diameter. There are three fairly standard diameter lenses, 58 mm, 77 mm, and 82 mm, but lens diameters can range from 30 mm up to 105 mm or more. The lens cover 60 of the preferred embodiment is sized to fit these most common lens sizes, but the lens cover 60 can be made in any size to fit any size camera lens. One advantage of the beveled walls and the flexible material is that it can fit some fairly close lens sizes. Because of the bevel of the walls 11 and 21, the lens cover 60 will be larger than the diameter of the front end 51 of the camera lens 50 but will engage the front of the camera lens 50 as the lens cover 60 moves onto the lens 50. For example it is possible for the same lens cover 60 to fit both the 72 mm and the 77 mm lens. As shown in FIGS. 10a & 10b, and 11a & 11b, the lens cover 60 will merely sit further up on the larger lens 50. The lens 50 of FIG. 10 a & b has a 77 mm diameter, and the lens 50 of FIG. 11a & b has an 82 mm diameter. As can be seen in FIG. 10b, the lens with the slightly smaller diameter will fit further up inside the lens cover 60, and the lens with the slightly larger diameter, shown in FIG. 11b will fit slightly lower inside the lens cover 60. This is true for either version, with or without the retainer ring 41. In either case the dome top 15 leaves the protective crumple zone or bumper area to protect the lens 50.

The lens cover 60 can come in many different sizes to fit a variety of different sized lenses 50. There is a small lens cover 60 that fits lenses with an outer diameter of between 60 and 70 mm (2 7/1602¾ inch), a medium lens guard 60 that fits lenses with an outer diameter of between 70 and 80 mm (2 13/16-3¼ inch), a large lens guard 60 that fits lenses with an outer diameter of between 80 and 90 mm (3 5/16-3⅝ inch), and extra large (X-L) lens guard 60 that fits lenses with an outer diameter of between 100 and 110 mm (3⅞-4⅜ inch), an extra-extra large (2×-L) lens guard 60 that fits lenses with an outer diameter of between 140 and 150 mm (5 9/16-5 15/16 inch), a jumbo lens guard 60 that fits lenses with an outer diameter of between 160 and 170 mm (6¼-6¾ inch), and a giant lens guard 60 that fits lenses with an outer diameter of between 195 and 205 mm (7¾-8⅛).

The tether 30 is designed to attach the lens cover 60 to the camera. FIG. 8 shows the lens cover 60 attached to the camera by means of the tether 30. In use a photographer will attach the camera end 34 of the tether 30 to the camera, and slip the lens cover 60 over the front end 51 of the camera lens 50. The beveled walls 11 and 21 will allow the lens cover 60 to easily fit over the end of the camera lens 50 and to slip into place, then the end of the camera lens will press into the soft inner liner 20, which will help hold the lens cover 60 in place on the camera lens 50. In the embodiment with the retainer ring 41, the retainer ring 41 helps hold the lens cover 60 in place. In fact, if the lens cover 60 with the retainer ring 41 is appropriately sized to the lens 50, the retainer ring 41 will hold the lens cover 60 in place on the lens 50 without the need of the tether. The lens cover 60 provides protection to the camera lens 50 as the photographer moves around. In most cases the camera is worn over the photographer's neck so that the camera lens 50 protrudes out from the photographer's chest. In many cases this means that the camera lens 50 is in a position to impact objects while the photographer is walking or moving. When in place the lens cover 60 provides a great deal of impact protection to the camera and camera lens 50. And when the photographer wants to take a picture, the lens cover 60 can be slipped off the end of the camera lens 50 and it will be held at the end of the tether 30 and in easy reach for replacement.

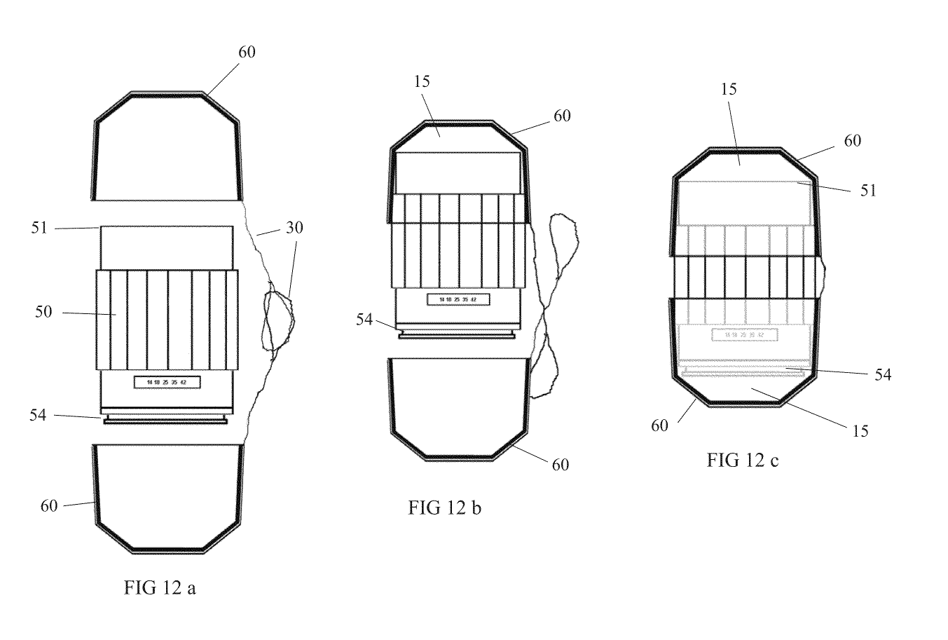

The camera lens mount end 54, which is well known in the art, is also tapered, and the lens cover 60 can be used to cover the lens mount 54 as well as the front end 51 of the lens 50. Many camera lens barrels 53 are relatively cylindrical so the front end 51of the lens and the mount end 54 of the lens are approximately the same size. That means that a lens cover 60 that fits the front of the camera lens will also be the appropriate size to cover the lens mount as well. Because the lens cover 60 can fit on both the lens end 51 and the mount end 54 of a lens 50, the lens cover 60 can be used to store, secure, and protect lenses 50 when they are not mounted on the camera. Because of their cost, protecting lenses is very important for photographers. The configuration of the lens cover 60 makes it suitable to easily protect a lens 50 with two lens covers 60. As seen in FIGS. 1a, 12b & 12c, two lens covers can be attached by means of the tether 30, and can slip on over both ends of the lens 50 to provide complete protection. If the tether 30 is made from elastic material the tethers 30 can be stretched and wrapped around the opposite lens guard 60 to provide complete protection.

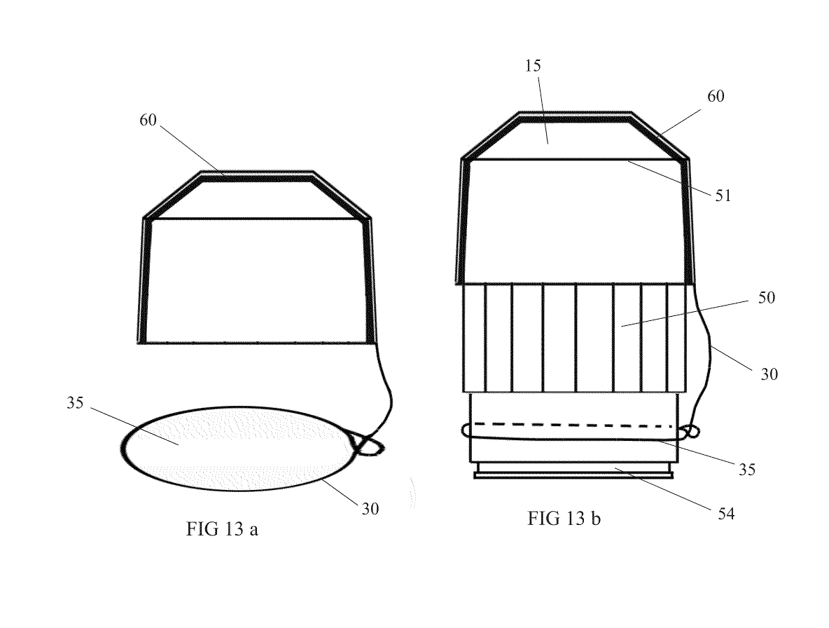

FIG. 13a shows the loop end 35 of the tether, and FIG. 13b shows the loop end 35 around the mount end 54 of the lens 50. This configuration can be used when the lens 50 is either on, or off, the camera. It is also possible to use this loop configuration of the tether 30 to protect both ends of the lens 50, as depicted in FIGS. 12a, b & c.

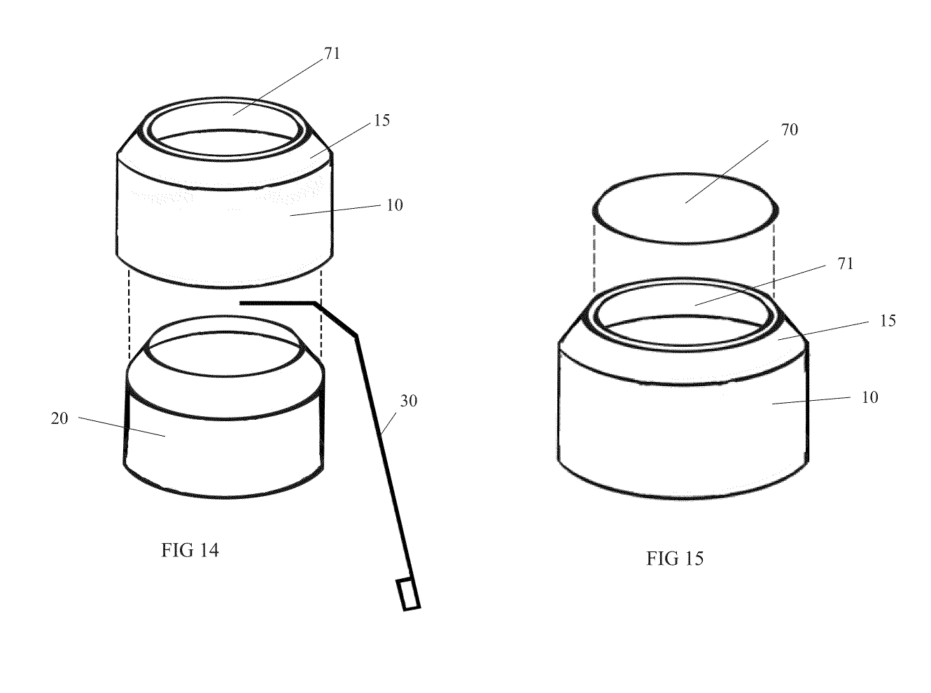

An alternate version of the lens cover 60 can incorporate a clear lens or filter 70 into the dome top 15. This variation is shown in FIGS. 14, 15, 16 & 17. In this variation of the invention there is a circular opening 71 in the domed top 15. In one variation there is an optical grade clear polycarbonate lens 70 integrated into the dome top 15 of the outer cup 10 in the circular opening 71. In this embodiment the inner liner 20 does not have a liner top 24. The clear lens 70 is sufficiently clear to allow a photographer to take a picture with the lens cover 60 in place. The dome top 15 portion is particularly important in this configuration since the inner liner 20 does not include the liner top 24 to provide padding at the end of the camera lens 50. If the end of the lens cover 60 comes into contact with a hard object, the domed top 15 will have compression room to provide shock absorption.

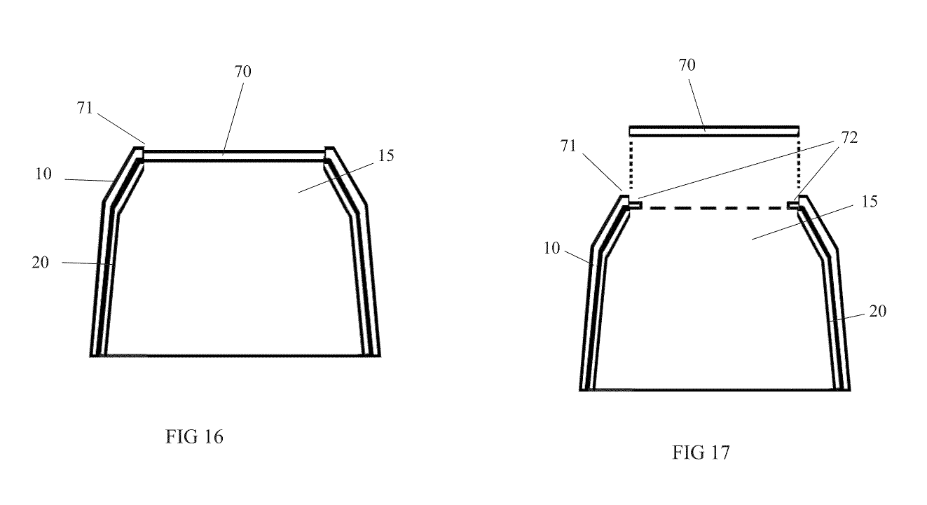

FIG. 14 is an exploded view of the lens cover 60 with the circular opening 71 at the domed top 15. FIG. 15 is an exploded view showing the clear lens 70 in position to be inserted into the circular opening 71. FIG. 16 is a cross section showing the clear lens 70 inserted into a circular opening 71 in the dome top 15. The top 14 of the dome 15 is circular, and the circular opening 71 is centered within the dome top 15. The cross section of FIG. 16 shows one variation of this alternate embodiment. In this embodiment the clear lens 70 is molded into place inside the dome top 15 of the outer cup 10. It is well known in the art to mold various plastic and polymer components together. The clear lens 70 is a piece of circular optical grade clear polycarbonate placed in the center of the dome top 15, and molded into place. In a second variation, shown in FIG. 17, the circular opening 71 has a circular circumferential lip 72 and the clear lens 70 is inserted against the lip 72 and secured in place. The clear lens 70 can also be glued into place within the circumferential lip 72. In this embodiment the photographer can take pictures through the clear lens 70 when the lens guard 60 is in place on the end of the camera lens 50.

In a variation of this embodiment the circular opening 71 is sized to accommodate a standard filter lens 70. Filter lenses 70 are well known in the art and come in standard diameters. In this variation of the invention the circular opening 71 can be the appropriate diameter to allow the standard filter lens to be inserted and held in place. Filter lenses have a threaded portion and screw into the front end 51 of the camera lens 50. It is possible, and within the conception of the invention, to incorporate a threaded lens mount into the circular opening 71 of the lens cover 60 to allow the lens cover 60 to accommodate a wide variety of filters 70.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A removable protective covering for a lens or other optical device comprising:
a protective outer cup having an inside surface and a cup interior space defined therein;
a protective inner liner sized to fit inside the cup interior space and against said inside surface, said protective inner liner having a liner interior space sized to fit over the lens or other optical device;
wherein said outer cup and inner liner have beveled walls having a top circumference and an opening circumference, said opening circumference being larger than said top circumference thereby giving said protective covering a frusto-conical shape, and wherein said opening circumference is slightly larger than said lens or other optical device and said top circumference is slightly smaller than said lens or other optical device such that said protective covering can easily slide onto and off of said lens or other optical device, and wherein inner liner can conform to lenses or optical devices of varying sizes to retain said protective covering in place and to provide protection to said lens or other optical device.

2. The removable protective covering of claim 1 further comprising:
a domed top having a dome wall and a cup top, said dome wall adjoined with said beveled cup wall and said cup top adjoined with said dome wall to create an enclosed domed top, wherein said enclosed domed top protrudes from said lens or other optical device when said protective covering is in place such that said enclosed domed top creates a hollow compression zone to provide impact protection to the lens or other optical device.

3. The removable protective covering of claim 1 further comprising:
a retainer ring disposed circumferentially on said inside surface of said protective outer cup, said retainer ring consisting of a ridge extending in to said interior space to create a circumferential ridge, and wherein said retainer ring allows the lens cover to conform more accurately to the size of the lens or other optical device.

4. The removable protective covering of claim 2 further comprising:
a retainer ring disposed circumferentially on said inside surface of said protective outer cup, said retainer ring consisting of a ridge extending in to said interior space to create a circumferential ridge, and wherein said retainer ring allows the lens cover to conform more accurately to the size of the lens or other optical device.

5. The removable protective covering of claim 1 further comprising;
a tether having a camera end and a cover end, said cover end fixedly attached to said protective covering, and said camera end designed for attachment to the camera.

6. The removable protective covering of claim 1 wherein said lens has a front end and a mount end and wherein said protective covering is sized to cover and protect either said front end or said mount end.

7. The removable protective covering of claim 6 wherein a lens can be protected at both ends by the use of two protective coverings.

8. The removable protective covering of claim 1 wherein said outer cup is made from a pliable and flexible material and wherein said inner liner is made from a soft material to provide maximum impact protection.

9. The removable protective covering of claim 8 wherein said pliable and flexible material is Santoprene, and wherein said soft material is neoprene.

10. The removable protective covering of claim 9 wherein said pliable and flexible material can be in any color of the visible spectrum.

11. The removable protective covering of claim 2 further comprising a circular opening within said domed top, wherein impact resistance is retained by the space within the central opening.

12. The removable protective covering of claim 11 wherein said circular opening is configured to receive an optical grade lens.

13. The removable protective covering of claim 4 further comprising a circular opening within said domed top, wherein impact resistance is retained by the space within the central opening.

14. The removable protective covering of claim 13 wherein said circular opening is configured to receive an optical grade lens.
